(19) United States
(12) Patent Application Publication
(10) Pub. No.: US 2019/0200809 A1
(43) Pub. Date: Jul. 4, 2019

(54) Long handled outdoor cooking and camping spatula

(71) Applicant: Chad Leakey, Knightstown, IN (US)

(72) Inventor: Chad Leakey, Knightstown, IN (US)

(21) Appl. No.: 16/237,939

(22) Filed: Jan. 2, 2019

Related U.S. Application Data
(60) Provisional application No. 62/613,183, filed on Jan. 3, 2018.

(51) Int. Cl. A47J 43/28

(52) U.S. Cl. CPC A47J 43/288

(57) ABSTRACT

A long handled outdoor camping spatula used as a utensil for cooking over a large open fire or grill while camping, backpacking or fishing. The device permits the user to avoid heat and exposure to flames. The device is a long handled outdoor camping device including a long up to 60 inch handle made of a durable and flame resistant material and configured with an angle notch. The device has a spatula blade made of flame resistant and food neutral materials and has other optional features. The handle and spatula blade are then securely connected and the device can be used to safely protect the user from the heat and flames of a grill or camp fire when cooking food.

### CROSS-REFERENCE TO RELATED APPLICATIONS

This application claims the benefit of U.S. Provisional Patent Application with Ser. No. 62/613,183 which was filed Jan. 3, 2018, by Chad Leakey. The application is entitled “Long handled outdoor cooking and camping spatula”.

### FIELD OF INVENTION

This invention relates to a long handled outdoor camping spatula. Further, the invention relates to a utensil for cooking over a relatively large open fire or grill while camping, backpacking or fishing. Avoidance of heat and exposure to flames are of the essence for these activities. Other camping spatulas however have shorter, stubby handles which allow exposure to the heat of the operator.

This invention provides a long handle up to 60 inches so the operator can avoid heat exposure. The present invention relates to a spatula, more particularly a spatula used for outdoor cooking. The present invention relates generally to hand implements and, more particularly, to spatula and food turning devices. Also it relates to a barbecue tool which facilitates handling of foods cooked on a grill. Finally, it relates to cooking, barbecuing, and grilling utensils generally and, more particularly, but not by way of limitation, to a novel spatula.

### FEDERALLY SPONSORED RESEARCH

None.

### SEQUENCE LISTING OR PROGRAM

None.

### BACKGROUND-FIELD OF INVENTION AND PRIOR ART

This section is not applicable to Provisional Applications. However, as far as known, there are no special long handled spatula or device or the like. It is believed that this product is unique in its design and technologies.

### Background

This background as spatulas and turning devices for grills should be useful. Spatulas are used for cooking in many environments including grilling, whether outdoor grilling over a fire or indoor cooking on a griddle surface. Not-with-standing the pervasive use of the spatula as a necessary cooking tool, prior art spatulas are not well adapted to provide comfort and ease of use in many cooking situations, especially with larger grills or fires. The outdoor grilling of hamburgers, chicken and fish is widely popular. Unfortunately, during grilling on relatively large grills or fires (greater than 3 feet in diameter), these sources of heat can have considerable effects and even burn an operator while reaching to turn or manipulate food being barbecued.

A typical large grill has more food to deal with so, when a conventional short handled spatula is used, the operator/cook is over reaching and closely exposed to the fire and heat. Thus they are likely to be burned or impacted from the uncomfortable heat. Just as often, the grilled food is mangled and rendered less appealing to eat by rough handling to avert the heat. In order to reduce tearing and disintegration of food items when they are being removed from a wire rod grill, various spatulas or food handling devices have been developed which have fingers, tines or projections to assist the handling. But none employ a long handle to reduce exposure to the heat or flames. Makeshift adapters or extensions are done in such manner as to compromise the integrity and strength of the spatula.

Accordingly, there remains a need for an improved, long handled grill spatula for use with larger grills and fires to more easily manipulate under the food item and lift it from the grill. This new spatula provides an enhanced capability to manage or contain foodstuffs. Accordingly, it is a principal object of the present invention to provide a device for manipulating and retrieving objects on large grills while avoiding over exposure to heat and flames from the grill or fire.

### Prior Art

Other prior art was searched, but as far as known there is no other prior art that provides the uniqueness and advantages of the long handled outdoor cooking and camping spatula as shown and described here. A novelty search discovered prior art that includes:
A. U.S. Design Pat. No. D785,416 by Knitting et al. was issued in 2017 and called a Grilling Utensil.
B. A U.S. Pat. No. 6,746,062 is entitled a Collapsible Grilling Spatula and was issued to Bielecki et al. in 2004. This shows a collapsible spatula for cooking over an open fire or grill which includes a perforated spatula face, a removable handle with retractable supports that can easily be assembled/or disassembled. Options include a collapsible spatula face having a hinge, a nonstick cooking surface, a serrated cooking edge, and a telescopic handle that includes a spring for biasing the rod in an extended state and a detent for maintaining a retracted state.
C. A U.S. Pat. No. 6,676,181 entitled a Grill Spatula was issued to Greiner in 2004. This shows a spatula for removing stuck food items from charcoal grills and liquid propane gas grills. The spatula has a handle and several flexible tines joined thereto. Arc-shaped blades are joined to the free ends of the tines. The arc-shaped blades conform closely to the top and side surfaces of the food supporting rods of a typical grill. When the spatula is used, the blades are slid along the rods to cleanly shear stuck food items from the grill without compromising the integrity of the food item.
D. A U.S. Pat. No. 6,247,736 called a Spatula was issued to Esterson et al. in 2001. This teaches a spatula that includes a handle connected to an asymmetrical flat head portion at an offset location on the flat head portion. The asymmetrical flat head portion includes a beveled perimeter edge with one side of the beveled edge including a plurality of serrations to provide a cutting capability for the flat head portion. The serrated edge of the flat head portion is further angled with respect to the handle to improve the operation of the spatula and safety of the user.
E. A U.S. Pat. No. 6,068,312 named a Barbeque Tool was issued to Hills in 2000. This demonstrates a grill spatula which includes a spatula head having a distal food handling portion and a proximal shank portion. The food handling portion defines a plurality of spaced apart fingers and a continuous plate section located between the fingers and the proximal shank portion. The fingers are sized and spaced apart so that they can be inserted between rods of a grill. The entire upper side of the food handling portion of the spatula head is flat. A heat resistant handle is fixed to the shank portion of the spatula head and extends proximally away from the shank portion. The arrangement allows the spatula head to be more easily slid under a food item and facilitates easy removal of food items from a grill without damaging the food item.
F. A U.S. Pat. No. 6,012,750 entitled a Spatula was issued to Swartz in 2000. Here is shown in one embodiment, a spatula for removing an object from a support surface and for substantially preventing the object from falling off during handling, the spatula including a blade having a top surface, a bottom surface, a front end and a rear end, wherein the blade has a prying portion including a distal end disposed at the front end of the blade and a proximal end, and wherein the blade has a cradle portion disposed rearwardly adjacent the prying portion and including a distal end attached to the proximal end of the prying portion, a proximal end, and a transverse stop section disposed between the distal and proximal ends of the cradle portion for arresting movement of the object upon the top surface of the blade.
G. A U.S. Pat. No. 4,711,029 entitled a Cookery Implement was issued to Somerset in 1987. This is a cookery implement having a handle and a spatula blade for contacting food being prepared. A plurality of puncturing prongs are provided at the side edge of the spatula blade near to the end edge remote from the handle, the tips of the puncturing prongs being directed sideways so that food can be punctured or pierced by movement of the blade in a direction generally transverse to the line from the handle to the food contacting end of the blade.
H. Next, a U.S. Pat. No. 3,213,779 called Spatula was issued to First in 1963. This invention relates to spatulas and, more particularly, to spatulas for use in combination with grills for lifting foods therefrom. The basic function of the spatula disclosed herein is to flip meat grilled on a wire type surface grill. Extreme difficulty is sometimes experienced in turning a grilled hamburger or cubed steaks as well as other meats and foods when charcoaled. The steaks and other foods Snag and stick to the wire. When using a conventional flat spatula, the spatula cuts the meat and breaks it into pieces or pushes the meat across the grill ahead of the spatula.
I. Finally, a U.S. Pat. No. 2,489,606 entitled a Spatula was issued to Allen in 1947. This invention provided a spatula which was relatively inflexible over its major portion but which has a highly flexible tip portion, so the tip portion may be slid down the side of a pan and may then bend abruptly along the bottom of the pan with the major portion of the spatula remaining stiff.
   As can be observed, none of the prior art has anticipated or caused one skilled in the art of spatulas and food turning devices for grills to view this new invention by the Leakey as obvious to a person skilled in the ordinary art of spatulas and the like of the food grilling industry. The spatula provides an answer to the existence of heat and flames during the grilling process and protects the user from those dangers. The new invention protects form these injuries from heat and flames as well as providing a better control on the foods being grilled by allowing the user to not worry and focus on the dangers but instead on the quality of the grilling itself.

### Problem Solved

The improvement and problem solved as to spatula or cooking devices is that the length of the handle permits the operator to avert exposure to the high heats of the grill as well as to manipulate the food on large grills and campfires while cooking.

### SUMMARY OF THE INVENTION

This invention is a long handled outdoor camping spatula for various applications. Taught here are the ways a spatula adapted with a long handle for preparing foods.

The preferred embodiment is a long handled outdoor camping device comprised of: (a) a long up to 60 inches comprised of a durable and flame resistant material and further comprised with an angle notch; (b) a spatula blade comprised of a durable, flame resistant and food neutral material and further comprised of an angle tine for mating with the handle, a top and bottom surface, a front edge opposite the tine, and other optional features; and (c) a means for securely connecting the handle to the spatula blade wherein the long handled outdoor camping device can be used to safely protect the user from the heat of a grill or camp fire when cooking food.

The newly invented long handled outdoor camping device can be manufactured at low volumes by very simple means and in high volume production by more complex and controlled systems.

### OBJECTS AND ADVANTAGES

There are several objects and advantages of the special long handled spatula or device. There are currently no known cooking or camping spatulas devices that are effective at providing the objects of this invention.

The Long handled outdoor cooking and camping device has various advantages and benefits:

| Item | Advantages |
|---|---|
| 1 | spatula has long handles for fire pits and large |
| | grills |
| 2 | spatula supports large grilling functions such as |
| | parties and large organization events |
| 3 | spatula drop angle strengthens attachment between |
| | handle and blade while keeping blade relatively |
| | flat with grill surface |
| 4 | spatula protects user from heat of grill |
| 5 | adjustable versions of length |
| 6 | various materials for handle such as wood- |
| | hickory, oak, teak, birch, etc.; metals - powder |
| | coated steel alloy, stainless steel, brass, |
| | copper; high temperature composite materials and |
| | plastics |
| 7 | multiple options - bottle cap opener, grill |
| | scraper, package opener and meat tenderizer |
| | notches, drip apertures |
| 8 | various materials for blade such as metals - |
| | plated steel alloy, stainless steel, brass, |
| | copper; high temperature composite materials and |
| | plated plastics |

Finally, other advantages and additional features of the present Special Long Handled Spatula will be more apparent from the accompanying drawings and from the full description of the device. For one skilled in the art of camping and outdoor cooking devices, it is readily understood that the features shown in the examples with this product are readily adapted to other types of cooking spatulas and other camping devices.

### DESCRIPTION OF THE DRAWINGS-FIGURES

The accompanying drawings, which are incorporated in and constitute a part of this specification, illustrate an embodiment of the long handled outdoor camping device for various applications device that is preferred. The drawings together with the summary description given above and a detailed description given below serve to explain the principles of the device. It is understood, however, that the long handled outdoor camping device is not limited to only the precise arrangements and instrumentalities shown.

FIGS. 1A through 1C are sketches of the general long handled camp spatula device for outdoor applications.

FIGS. 2A through 2C are sketches of the general Special Long Handled Spatula device with components and features noted.

FIGS. 3A and 3B are additional sketches of the Special Long Handled Spatula device with the components and features shown from generally a top view.

FIGS. 4A through 4G are isometric sketches of the various designs of the Special Long Handled Spatula device with components and features noted.

FIGS. 5A through 5C are sketches of the of the Special Long Handled Spatula device design drawings.

FIGS. 6A through 6D are sketches of the design patent application drawings for the Special Long Handled Spatula device.

FIG. 7 is a sketch of the original concept drawings for the Special Long Handled Spatula device.

FIG. 8 is a sketch of the original details for the Special Long Handled Spatula device with various components explained.

FIGS. 9A and 9B are sketches of the prototype Special Long Handled Spatula with components noted.

FIGS. 10A through 10D are sketches of the Special Long Handled Spatula being used in outdoor cooking and camping events.

FIGS. 11A through 11D are sketches of prior art for spatula devices.

### DESCRIPTION OF THE DRAWINGS-REFERENCE NUMERALS

The following list refers to the drawings:

TABLE B
Reference numbers

| Ref # | Description |
|---|---|
| 30 | special long handled device or spatula 30 for |
| | outdoor cooking and camping |
| 31 | design sketches 31 of a special long handled |
| | spatula |
| 33 | concept sketch 33 |
| 34 | concept details 34 |
| 35 | prototype 35 of a special long handled spatula |
| 40 | spatula handle 40 |
| 42 | handle angled connection surface 42 |
| 45 | means for securing 45 blade drop angle 52 to |
| | handle 40 at connection surface 42 such as |
| | rivet, bolt, screw, pins, or equal |
| 50 | spatula blade 50 |
| 51 | blade head 51 |
| 52 | continuous blade drop angle 52 |
| 52A | bend angle 52A at blade head 51 |
| 53 | optional separate blade tine 53 |
| 54 | optional means 53 to connect separate blade tine |
| | 53 to blade head 51 such as brazing, welding, |
| | integral forming and threaded fasteners |
| 55 | spatula blade top surface 55 |
| 57 | spatula blade bottom surface 57 |
| 58 | apertures 58 for drainage on blade 50 |
| 59 | front edge 59 of blade 50 |
| 60 | optional handle end cap 60 |
| 62 | hanger means 62 loop, staple, hook |
| 64 | optional cap opener aperture 64 |
| 70 | package breaker or tenderizer notches 70 |
| 80 | Prior art 80 U.S. Pat. No. 4,848,816 |
| 81 | prior art 81 U.S. Pat. No. 6,247,736 |
| 82 | prior art 82 U.S. Pat. No. 2,489,606 |
| 83 | prior art 83 U.S. Pat. No. 4,711,029 |
| 90 | relatively large outdoor fire pit/and grill 90 |
| 100 | using 100 the special long handled spatula 30 |
| | with a grill 90 |
| 110 | operator 110 |

### DETAILED DESCRIPTION OF PREFERRED EMBODIMENT

The present development is a long handled outdoor cooking and camping device and a long handled spatula for outdoor use. Further, the invention relates to a utensil for cooking over a relatively large open fire or grill while camping, backpacking or fishing. Avoidance of heat and exposure to flames are of the essence for these activities. Other camping spatulas however have shorter, stubby handles which allow exposure to the heat of the operator.

This invention provides a long handle up to 60 inches so the operator may avoid heat exposure. The present invention relates to a spatula, more particularly a spatula used for outdoor cooking. The present invention relates generally to hand implements and, more particularly, to spatula and food turning devices. Also it relates to a barbecue tool which facilitates handling of foods cooked on a grill. Finally, it relates to cooking, barbecuing, and grilling utensils generally and, more particularly, but not by way of limitation, to a novel spatula.

The advantages for the long handled outdoor camping and cooking device 30 are listed above in the introduction. Succinctly the benefits are that the device:
spatula has long handles for fire pits and large grills
spatula supports large grilling functions such as parties and large organization events
spatula drop angle strengthens attachment between handle and blade while keeping blade relatively flat with grill surface
spatula protects user from heat of grill
adjustable versions of length
various materials for handle such as wood—hickory, oak, teak, birch, etc.; metals—powder coated steel alloy, stainless steel, brass, copper; high temperature composite materials and plastics
multiple options—bottle cap opener, grill scraper, package opener and meat tenderizer notches, drip apertures
various materials for blade such as metals—plated steel alloy, stainless steel, brass, copper; high temperature composite materials and plated plastics

The preferred embodiment is a long handled outdoor camping device comprised of: (a) a long up to 60 inches comprised of a durable and flame resistant material and further comprised with an angle notch; (b) a spatula blade comprised of a durable, flame resistant and food neutral material and further comprised of an angle tine for mating with the handle, a top and bottom surface, a front edge opposite the tine, and other optional features; and (c) a means for securely connecting the handle to the spatula blade wherein the long handled outdoor camping device can be used to safely protect the user from the heat of a grill or camp fire when cooking food.

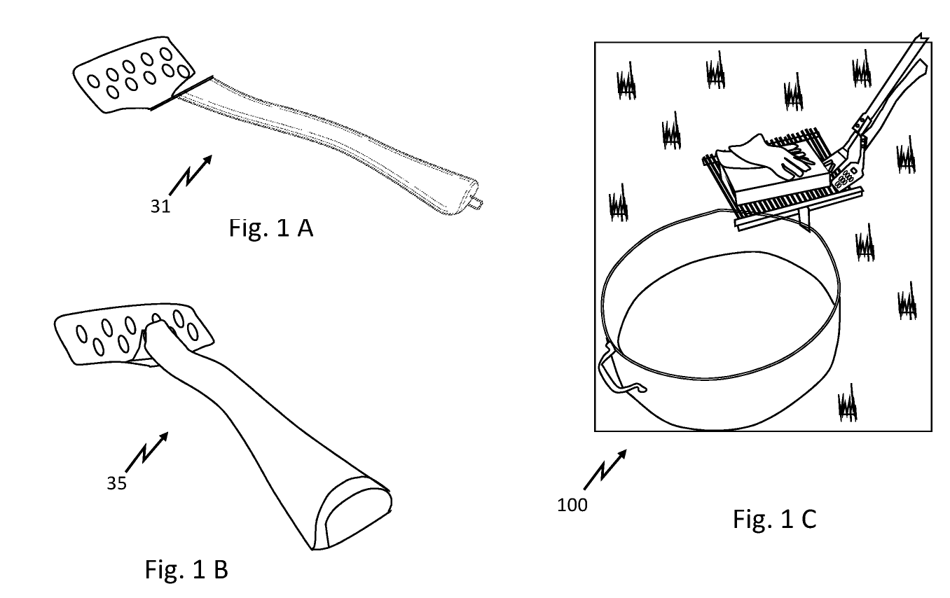

There is shown in FIGS. 1-11 a complete description and operative embodiment of the long handled outdoor camping device as described within. In the drawings and illustrations, one notes well that the FIGS. 1-11 demonstrate the general configuration and use of this product. The various example uses are in the operation and use section, below.

The accompanying drawings, which are incorporated in and constitute a part of this specification, illustrate an embodiment of the long handled outdoor camping device 30 that is preferred. The drawings together with the summary description given above and a detailed description given below serve to explain the principles of the long handled outdoor camping device 30. It is understood, however, that the long handled outdoor camping device 30 is not limited to only the precise arrangements and instrumentalities shown. Other examples of camping and spatula devices and uses are still understood by one skilled in the art of camping and outdoor cooking devices to be within the scope and spirit shown here.

FIGS. 1A through 1C are sketches of the general long handled camp spatula device 30 for outdoor applications. In these sketches are shown: design sketches 31 of a special long handled spatula; a prototype 35 of a special long handled spatula and using 100 the special long handled spatula 30 with a grill 90.

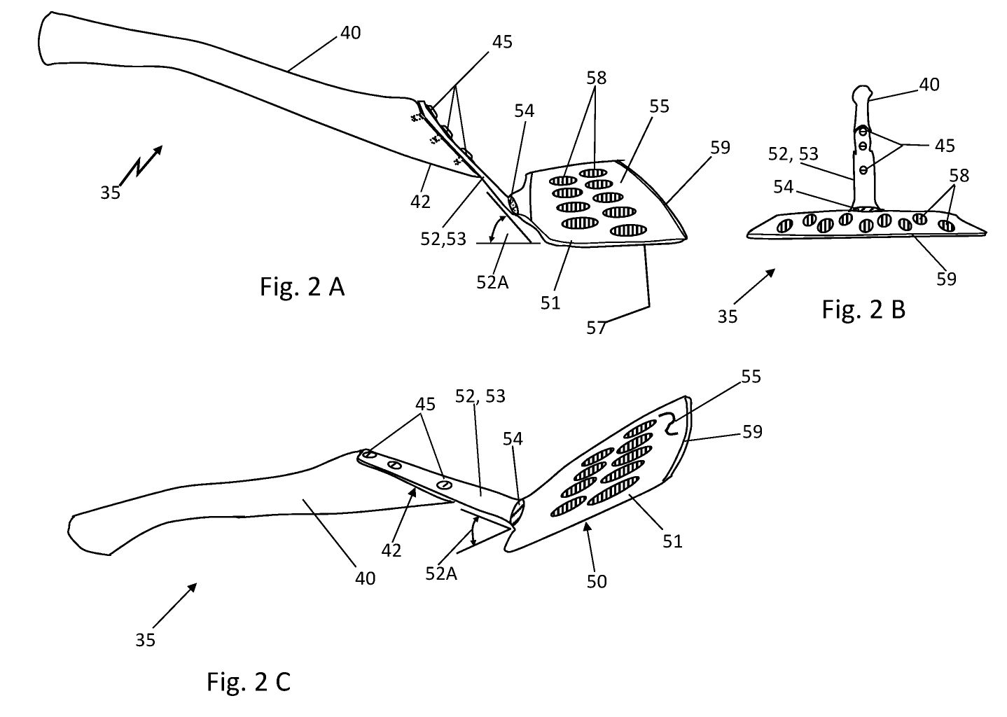

FIGS. 2A through 2C are sketches of the general Special Long Handled Spatula device with components and features noted. Portrayed in these sketches are: a prototype 35 of a special long handled spatula; a spatula handle 40 with a holding end and blade attachment end; an angled connection surface 42 at the blade connection end; a means for securing 45 blade drop angle 52 to handle 40 at connection surface 42 such as rivet, bolt, screw, pins, or equal; a spatula blade 50; a blade head 51; a continuous blade drop angle 52; a bend angle 52A at blade head 51; an optional separate blade tine 53; an optional means 53 to connect separate blade tine 53 to blade head 51 such as brazing, welding, integral forming and threaded fasteners; a spatula blade top surface 55; a spatula blade bottom surface 57; a set of apertures 58 for drainage on blade 50; a front edge 59 of blade 50; and a hanger means 62 such as a loop, eyebolt, staple, hook, or ring.

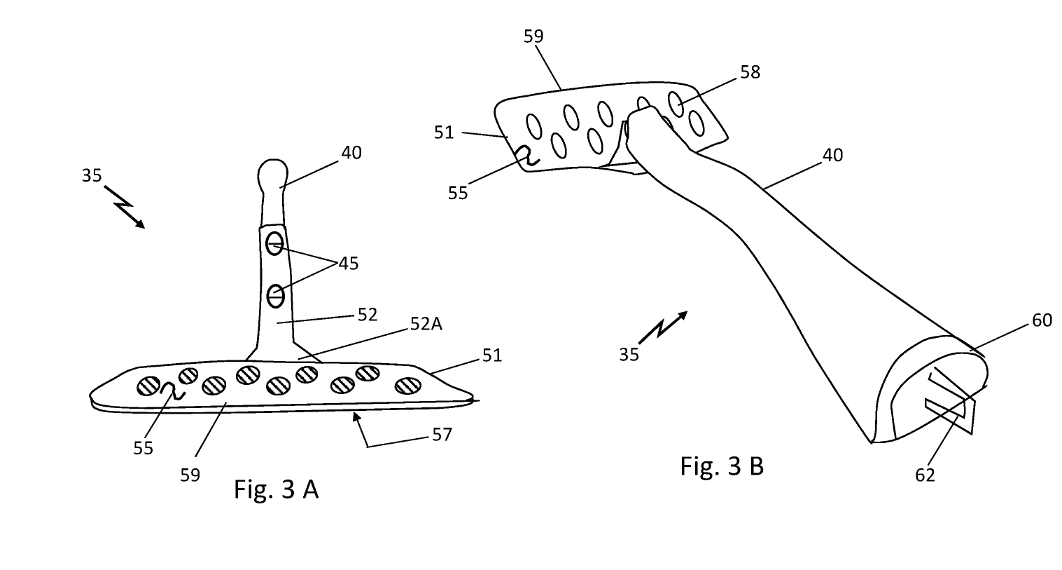

FIGS. 3A and 3B are additional sketches of the Special Long Handled Spatula device 30 with the components and features shown from generally a top view. Here are displayed and revealed: a prototype 35 of a special long handled spatula; a spatula handle 40 with a holding end and blade attachment end and made of durable and flame retardant material; a means for securing 45 blade drop angle 52 to handle 40 at connection surface 42 such as rivet, bolt, screw, pins, or equal; a blade head 51 made of durable and flame retardant material; a continuous blade drop angle 52; a bend angle 52A at blade head 51; a spatula blade top surface 55; a spatula blade bottom surface 57; a set of apertures 58 for drainage on blade 50; a front edge 59 of blade 50; an optional handle end cap 60; and a hanger means 62 loop, staple, hook. The durable and flame retardant material for the handle 40 includes materials such as wood, metal, flame retarded composite materials, and flame retarded plastics such as polyvinyl chloride, polyester, and polyethylene. The durable and flame retardant material for the blade head 51 includes materials such as metal (steel, stainless steel, steel alloy, and aluminum), flame retarded composite materials, and flame retarded plastics such as polyvinyl chloride, polyester, and polyethylene.

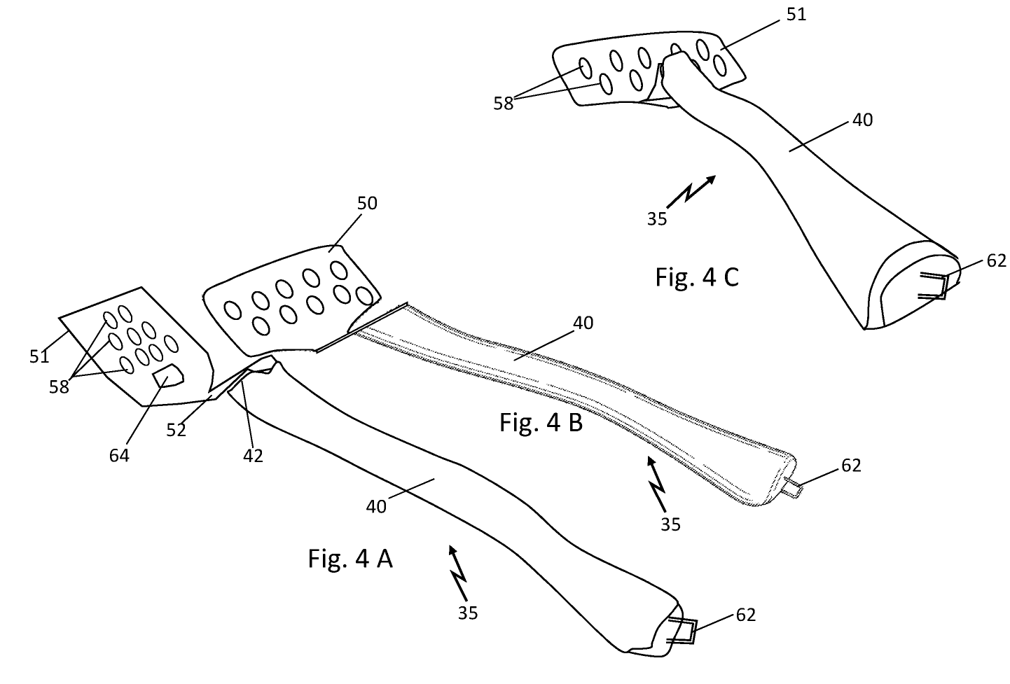

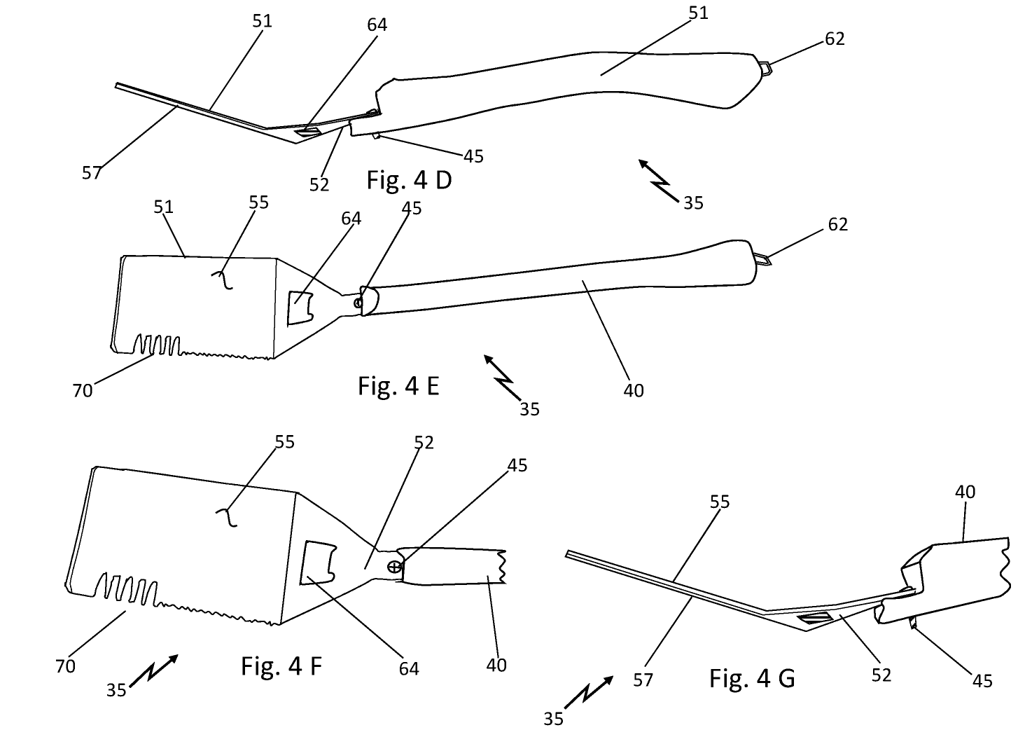

FIGS. 4A through 4G are isometric sketches of the various designs of the Special Long Handled Spatula device with components and features noted. Features and components noted in these views include: a prototype 35 of a special long handled spatula; a spatula handle 40 with a holding end and blade attachment end; a handle angled connection surface 42; a means for securing 45 blade drop angle 52 to handle 40 at connection surface 42 such as rivet, bolt, screw, pins, or equal; a spatula blade 50; a blade head 51; a continuous blade drop angle 52; a bend angle 52A at blade head 51; a spatula blade top surface 55; a spatula blade bottom surface 57; a set of apertures 58 for drainage on blade 50; a front edge 59 of blade 50; an optional handle end cap 60; a hanger means 62 loop, staple, hook; an optional cap opener aperture 64; and a package breaker or tenderizer notches 70.

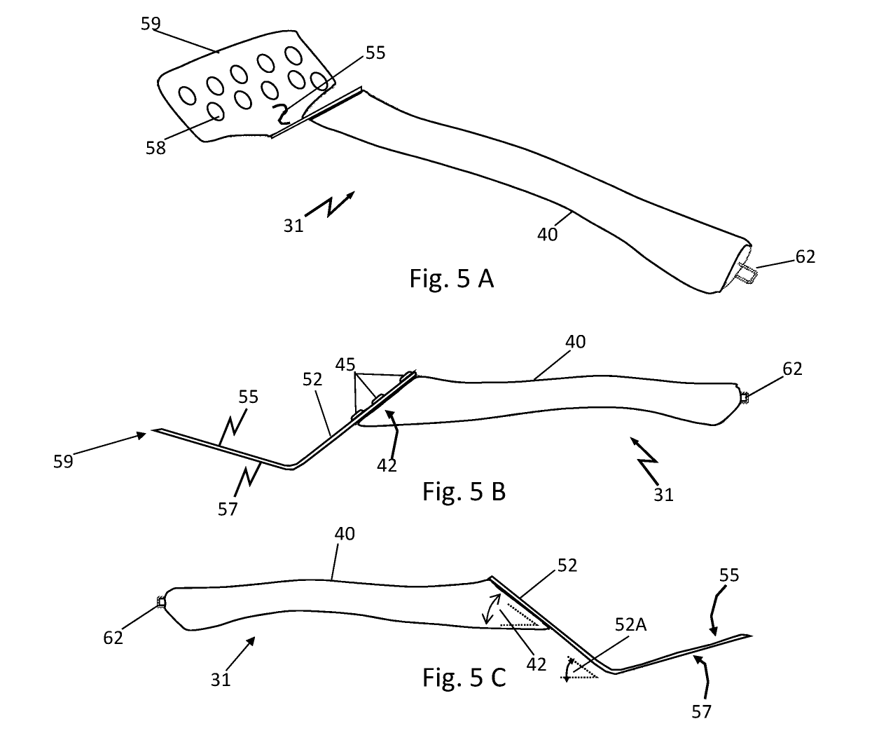

FIGS. 5A through 5C are sketches of the Special Long Handled Spatula device 30 design drawings and sketches 31. Provided here are components and details: design sketches 31 of a special long handled spatula; a spatula handle 40 with a holding end and blade attachment end; a handle angled connection surface 42; a means for securing 45 blade drop angle 52 to handle 40 at connection surface 42 such as rivet, bolt, screw, pins, or equal; a spatula blade 50; a blade head 51; a continuous blade drop angle 52; a bend angle 52A at blade head 51; a spatula blade top surface 55; a spatula blade bottom surface 57; a set of apertures 58 for drainage on blade 50; a front edge 59 of blade 50; an optional handle end cap 60; a hanger means 62 loop, staple, hook; an optional cap opener aperture 64; and a package breaker or tenderizer notches 70.

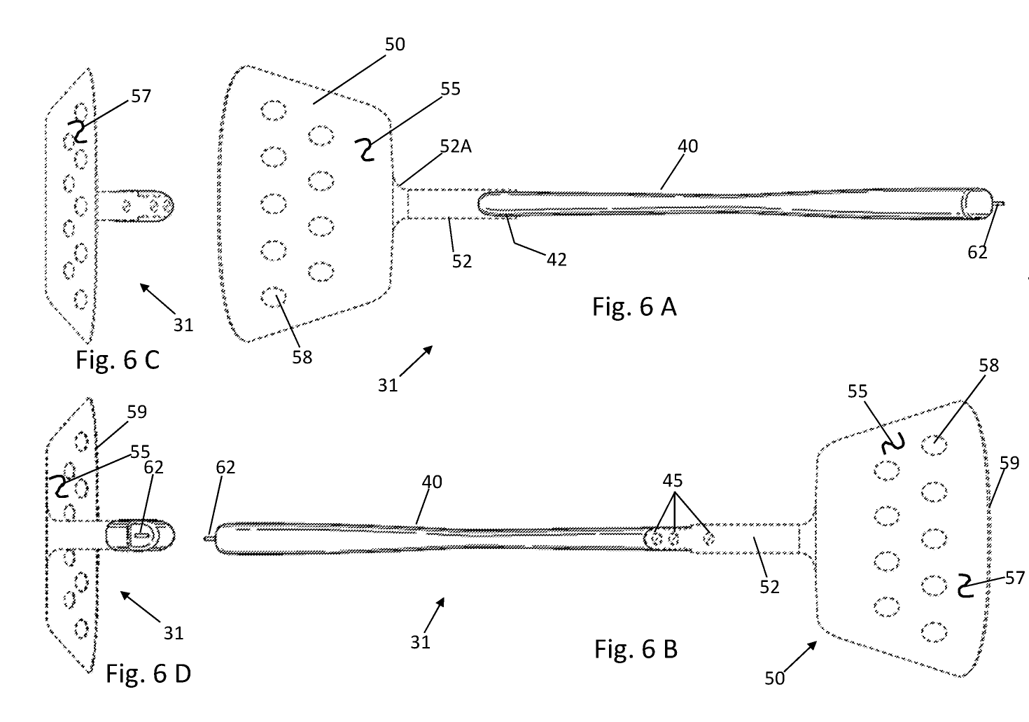

FIGS. 6A through 6D are sketches from the design patent application drawings 31 for the Special Long Handled Spatula device. These sketches show the components described in sketches from various other views. The spatula flat is shown in broken lines for illustrative purposes only and forms no part of the claimed design. The Petitioner, Chad Leakey, a resident and citizen of the United States of America whose address is KNIGHTSTOWN, Ind., US, prayed that the design patent may be granted to him for the new, original and ornamental design of a Long handled outdoor camping spatula as set forth in the following specification for use as a tensioner device for a rope or cord. The application number was 29618225 and the Patent was issued Jan. 1, 2019 as D836,975 by Chad Leakey.

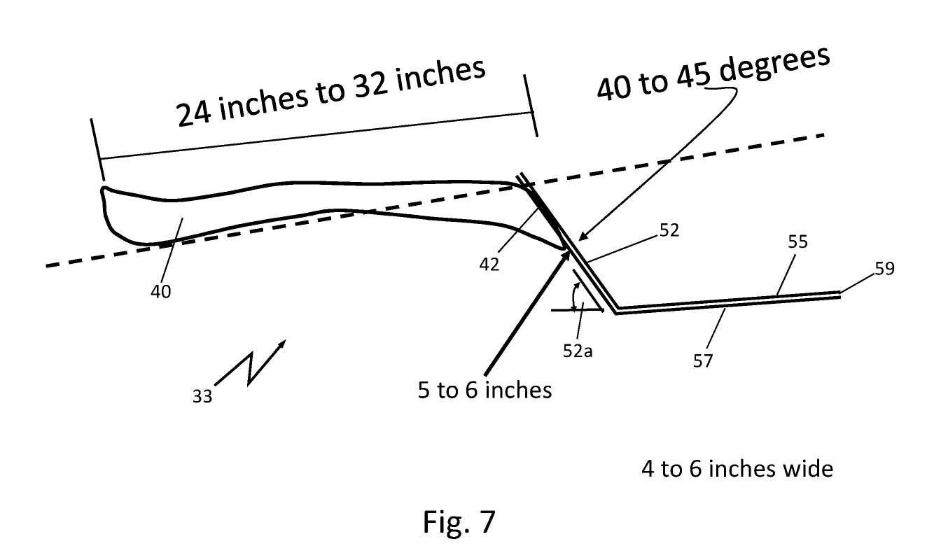

FIG. 7 is a sketch of the original concept drawings for the Special Long Handled Spatula device. This sketch shows: a special long handled spatula or device 30 for outdoor cooking; a concept sketch 33; a handle angled connection surface 42; a blade head 51; a continuous blade drop angle 52; a bend angle at blade head 51; a spatula blade top surface 55; a spatula blade bottom surface 57; and a front edge 59 of blade 50.

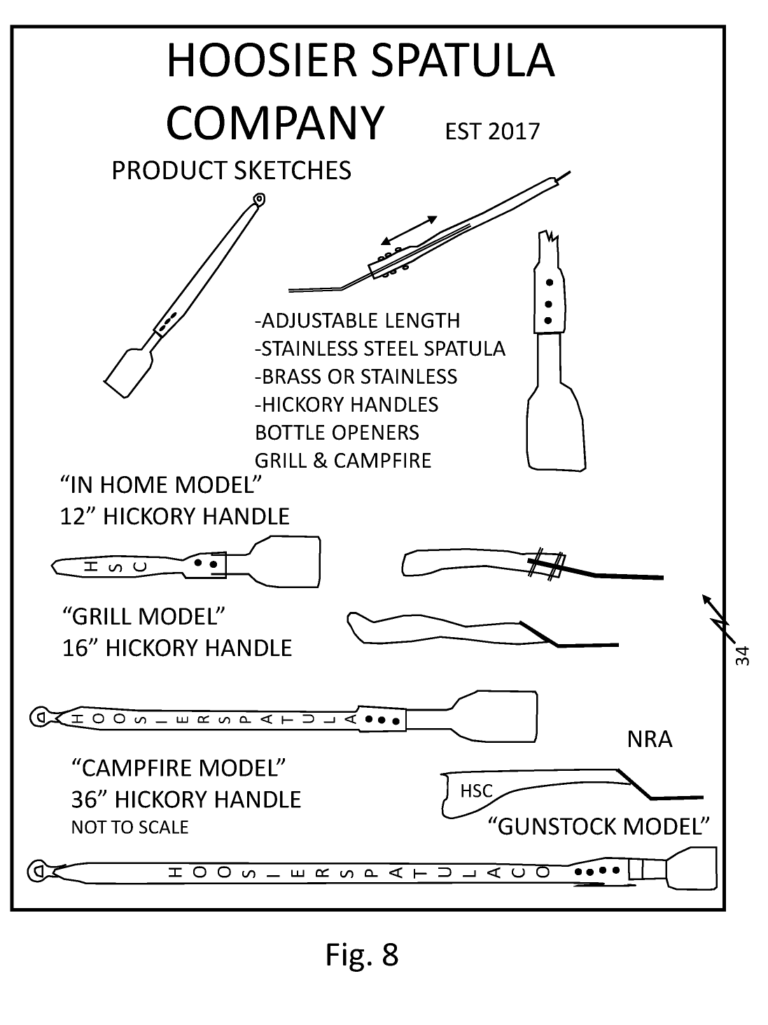

FIG. 8 is a sketch 34 of the original details for the Special Long Handled Spatula device 30 with various components explained, advantages and options explained.

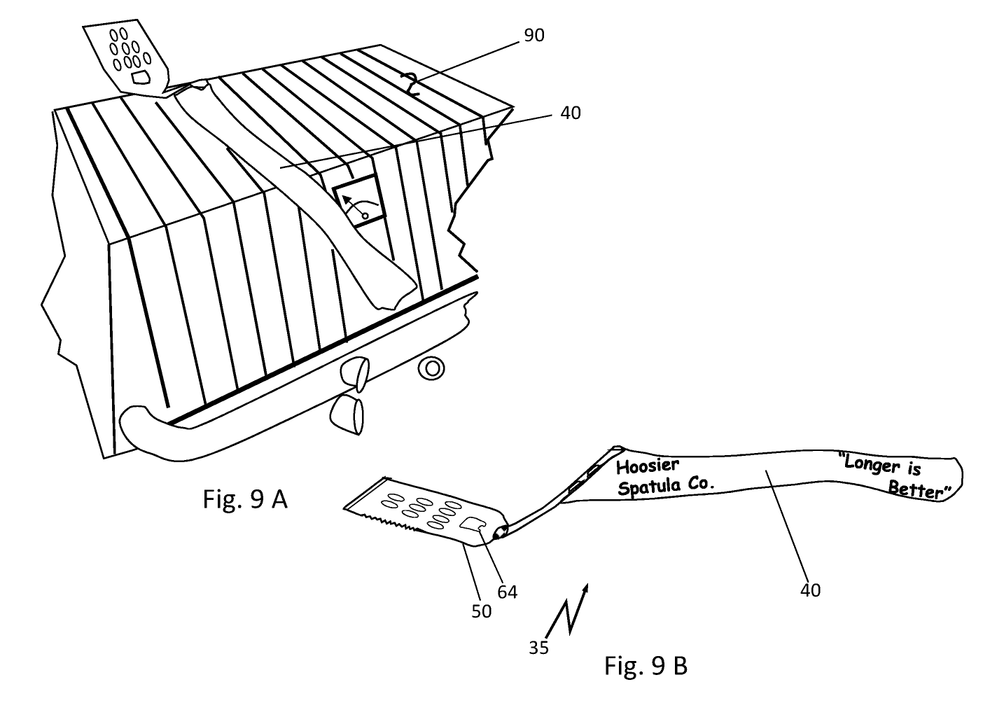

FIGS. 9A and 9B are sketches of the prototype 35 Special Long Handled Spatula with components noted. Features and components detailed here are: a prototype 35 of a special long handled spatula; a spatula handle 40; a spatula blade 50; an optional cap opener aperture 64; and a relatively large outdoor grill 90.

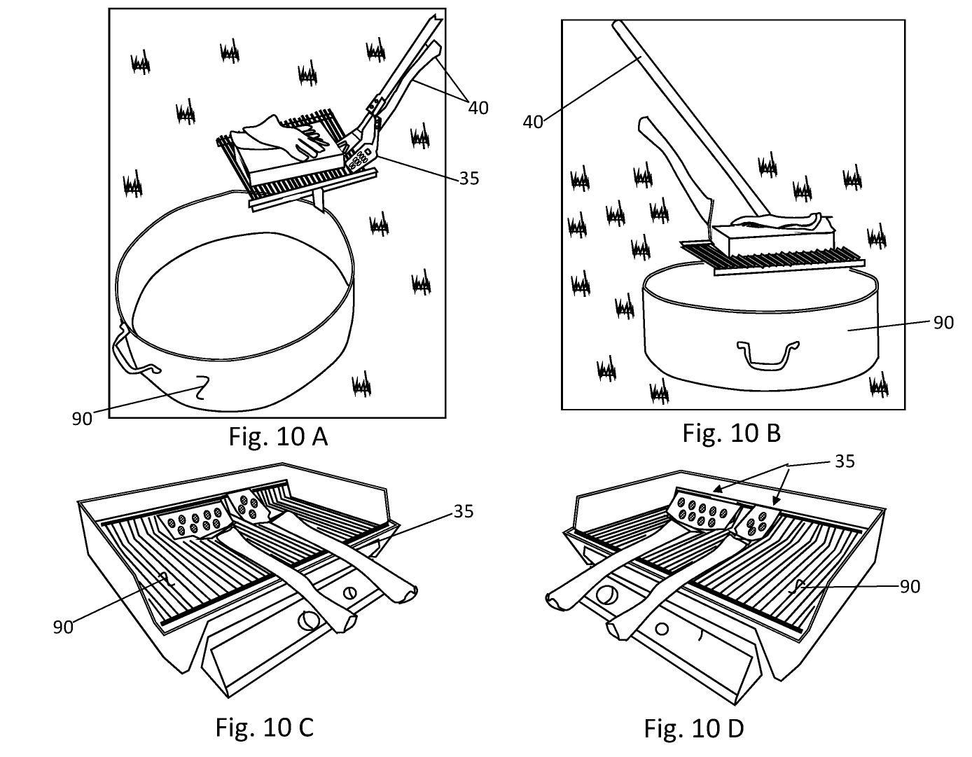

FIGS. 10A through 10D are sketches of the Special Long Handled Spatula 30 being used in outdoor cooking and camping events. This is described below in the operations section.

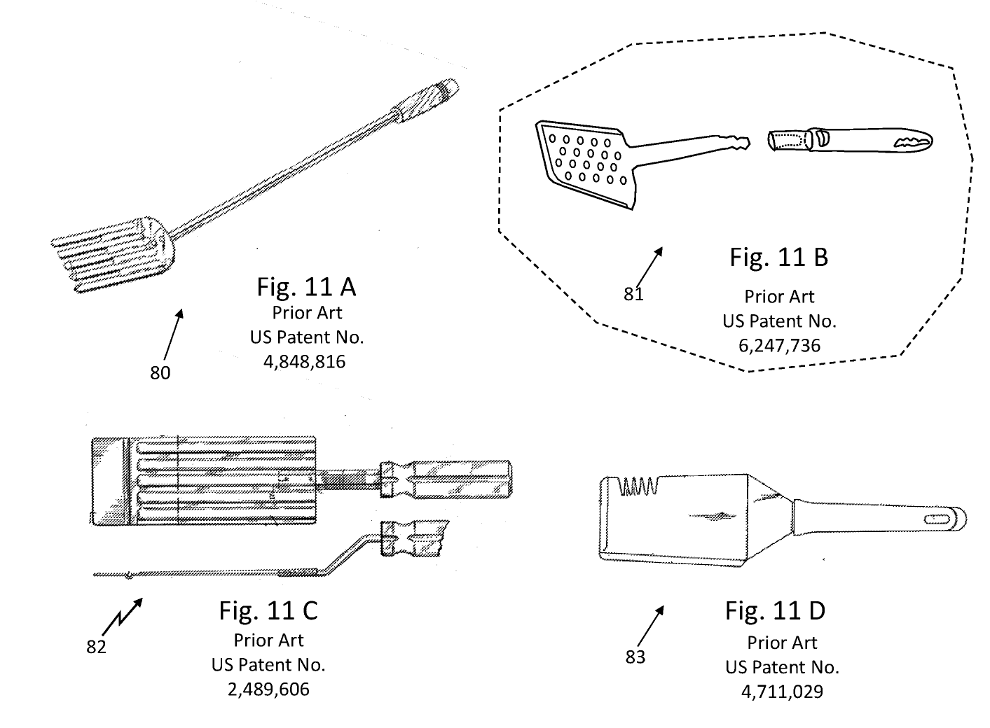

FIGS. 11A through 11D are sketches of prior art for spatula devices. Here former patents and applications for various spatula devices are shown. These include: a prior art 80 U.S. Pat. No. 4,848,816; a prior art 81 U.S. Pat. No. 6,247,736; a prior art 82 U.S. Pat. No. 2,489,606; and a prior art 83 U.S. Pat. No. 4,711,029.

The details mentioned here are exemplary and not limiting. Other specific components and manners specific to describing a long handled outdoor camping device 30 may be added as a person having ordinary skill in the field of the art of outdoor camping and cooking devices and their uses well appreciates.

### Operation of the Preferred Embodiment

The long handled outdoor camping device 30 has been described in the above embodiment. The manner of how the device operates is described below. One notes well that the description above and the operation described here must be taken together to fully illustrate the concept of the long handled outdoor camping device 30. The preferred embodiment is a long handled outdoor camping device comprised of: (a) a long up to sixty (60) inches comprised of a durable and flame resistant material and further comprised with an angle notch; (b) a spatula blade comprised of a durable, flame resistant and food neutral material and further comprised of an angle tine for mating with the handle, a top and bottom surface, a front edge opposite the tine, and other optional features; and (c) a means for securely connecting the handle to the spatula blade wherein the long handled outdoor camping device can be used to safely protect the user from the heat of a grill or camp fire when cooking food.

The long handled outdoor camping device 30 operates somewhat similar to a conventional spatula as far as turning and preparing various foods. The uniqueness comes with the manner of solving the problem of being too close to a grill or heat and fire and thus being exposed to high heats and potential burning of oneself conditions. The handle 40 is held and moved by the operator 110. By turning and manipulating the handle, the blade 50 of the device 30 can pick-up or deliver food to the grill as well as turn or flip the food over to various positions. The length of the handle permits the operator 110 to avert exposure to the high heats of the grill 90 as well as to manipulate the food on large grills and campfires while cooking.

FIGS. 10A through 10D are sketches of the Special Long Handled Spatula 30 being used in outdoor cooking and camping events. These sketches demonstrate and show: a prototype 35 of a special long handled spatula; a long (up to 60 inches) and the using 100 of the special long handled spatula 30 with a grill 90.

Many uses are anticipated for the long handled outdoor camping device 30. Some examples, and not limitations, are shown in the following Table.

| ITEM | DESCRIPTION |
|---|---|
| 1 | Sporting events with large fires and |
| | grills etc. |
| 2 | Campsite events where many people gather |
| | with large grills or fires |
| 3 | Large gatherings of organizations where |
| | larger quantities of food are produced on |
| | large grills or large fires |
| 4 | Showcase or competition cooking events |

With this description it is to be understood that the long handled outdoor camping device 30 is not to be limited to only the disclosed embodiment of product. The features of the long handled outdoor camping device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. A long handled outdoor camping device comprised of:
(a) a long, up to 60 inches, handle comprised of a durable and flame resistant material with a holding end and blade attachment end;
(b) a spatula blade comprised of a durable, flame resistant and food neutral material and further comprised of an angle tine for mating with the handle, a top and bottom surface, a front edge opposite the tine, and other optional features; and
(c) a means for securely connecting the handle to the spatula blade
wherein the long handled outdoor camping device can be used to safely protect the user from the heat of a grill or camp fire when cooking food.

2. The long handled outdoor camping device in claim 1 wherein the long handle is further comprised with an angle notch at the blade attachment end.

3. The long handled outdoor camping device in claim 1 wherein the long handle is further comprised with a hanger means.

4. The long handled outdoor camping device in claim 3 wherein the hanger means is selected from a group consisting of a loop, an eyebolt, a staple, a hook, and a ring.

5. The long handled outdoor camping device in claim 1 wherein the means for securely connecting the handle to the spatula blade is selected from the group consisting of rivet, bolt, screw, and pins.

6. The long handled outdoor camping device in claim 1 wherein durable material of the spatula blade is selected from a group consisting of metal, a flame retarded composite material, and a flame retarded plastic.

7. The long handled outdoor camping device in claim 6 wherein metal is selected from a group consisting of steel, stainless steel, steel alloy, and aluminum.

8. The long handled outdoor camping device in claim 6 wherein plastic is selected from a group consisting of polyvinyl chloride, polyester, and polyethylene.

9. The long handled outdoor camping device in claim 1 wherein the spatula blade is further comprised such that the tine is a separate blade tine and there is a means to connect the separate blade tine to the blade head.

10. The long handled outdoor camping device in claim 9 wherein the means to connect the separate blade tine to the blade head is selected from a group consisting of brazing, welding, integral forming, and threaded fasteners.

11. A long handled outdoor camping device comprised of:
(a) a long, up to 60 inches, handle comprised of a durable and flame resistant material with a holding end and blade attachment end and having an angle notch at the blade attachment end;
(b) a spatula blade comprised of a durable, flame resistant and food neutral material and further comprised of a top and bottom surface, and a front edge opposite the tine;
(c) a separate blade tine opposite the front edge;
(d) a means to connect the separate blade tine to the blade head; and
(e) a means for securely connecting the handle to the spatula blade
wherein the long handled outdoor camping device can be used to safely protect the user from the heat of a grill or camp fire when cooking food.

12. The long handled outdoor camping device in claim 11 wherein the long handle is further comprised with a hanger means.

13. The long handled outdoor camping device in claim 12 wherein the hanger means is selected from a group consisting of a loop, an eyebolt, a staple, a hook, and a ring.

14. The long handled outdoor camping device in claim 11 wherein the means for securely connecting the handle to the spatula blade is selected from the group consisting of rivet, bolt, screw, and pins.

15. The long handled outdoor camping device in claim 11 wherein durable material of the spatula blade is selected from a group consisting of metal, a flame retarded composite material, and a flame retarded plastic.

16. The long handled outdoor camping device in claim 15 wherein metal is selected from a group consisting of steel, stainless steel, steel alloy, and aluminum.

17. The long handled outdoor camping device in claim 15 wherein plastic is selected from a group consisting of polyvinyl chloride, polyester, and polyethylene.

18. The long handled outdoor camping device in claim 11 wherein the means to connect the separate blade tine to the blade head is selected from a group consisting of brazing, welding, integral forming, and threaded fasteners.
